(19) United States
(12) Patent Application Publication
(10) Pub. No.: US 2015/0261208 A1
(43) Pub. Date: Sep. 17, 2015

(54) ENGRAVED PRODUCT DESIGN SOFTWARE

(71) Applicant: Rayzist Photomask, Inc., Vista, CA (US)

(72) Inventors: Roderick Geis, Vista, CA (US); Josh Willis, Vista, CA (US)

(73) Assignee: Rayzist Photomask, Inc., Vista, CA (US)

(21) Appl. No.: 14/216,133

(22) Filed: Mar. 17, 2014

(51) Int. Cl. G05B 19/4097

(52) U.S. Cl. CPC G05B 19/4097; G05B 2219/45163

(57) ABSTRACT

The present invention provides, in at least one embodiment, a computer software program configured to receive information from a customer, provide one or more design template choices, and receive an order of a design of an engraved product from the customer. The design can be created by the customer as opposed to a professional artist and can allow the customer to see with confidence what the finished engraved product is going to look like prior to ordering. The computer software program includes an order tracking module which allows the customer to track the order throughout production and delivery.

### BACKGROUND OF THE INVENTION

1. Field of Invention

The invention relates generally to a computer software program for designing and ordering an engraved product, and more particularly, to a computer software program that improves the designing and ordering process.

2. Description of Related Art

Engraving is the practice of incising a design onto a typically hard surface by cutting grooves into the surface. Common surfaces to engrave include glass, wood, stone or any other hard surface that will abrade away.

One type of engraved product is a memorial that is engraved into a stone. In this product, the engraving creates a design on the memorial. Memorials serve as an object for the memory of a person or an event, often honoring and preserving the memory of someone who has died. A common type of memorial is a headstone. The headstone, also referred to as a gravestone or a tombstone, is placed over a grave for a traditional burial. Another type of memorial is a memorial plaque, which commemorates the memory of an event or one or more people. Other memorials include sculptures, statues, fountains and landmark objects such as a park bench.

Another type of engraved product is a skateboard. A traditional skateboard includes a deck, also referred to as the board, with grip tape applied on top of the deck to enhance traction and a design on the underside of the deck, a wheel assembly, and the nuts and bolts to fasten everything together. The design on the underside of the deck can be printed from the manufacturer, blank, or decorated by any other means.

FIG. 1 illustrates a conventional memorial ordering system 100 that exists in the prior art. The system 100 includes a customer 105, a salesperson 110, a computer 115, a vender 120, a graphical artist 125, collected information 130, and a design layout 135.

The salesperson 110 collects information from the customer 105 about the customer's desired design. In the memorial embodiment, the customer 105 may be the family of a deceased person, the salesperson is a cemetery counselor, and the information may include the deceased person's name, date of birth, date of death, and a memorable quote. In the memorial embodiment, the customer 105 has already bought a casket, a plot, and flowers, but usually does not buy the memorial at the same time because the customer does not know exactly what the engraved design is going to look like.

Typically, the collected information 130 is sent from the salesperson 110 to the vender 120 via email using the computer 115. Then, the vender 120 produces the design layout 135 including the collected information for the customer's approval, where the customer can view the design layout 135 and provide their approval via a return email through the computer 115 or the customer 105 can visit the vender 120 to approve the design. Although sometimes the customer approves the design layout 135 without changes and the purchase can be made at that point, other times the customer prefers to make changes such as font size of the deceased's last name.

However, this process of obtaining the customer's approval for the design layout 135 highlights a problem in the engraving industry, which is the inability to show the customer exactly what their design will look like, while the customer is still at the retail location and ready and willing to make a purchase.

One reason for this problem is that the current engraving process requires the collected information 130 to be sent to the vender 120 to produce the design layout 135, a step which is undesirable. This is undesirable because the customer must wait (e.g., usually 2-3 days) for the vendor 120 to provide the design layout 135 (e.g., sample, template, etc.) of what the memorial will look like, but by then, a large percentage of customers have changed their mind and have decided to not purchase the memorial. This leads to wasted time and effort, and just as important, the number of sales drop by approximately 40% after the customer walks out the door, for a customer who had already submitted a design and was ready to make a purchase.

One way to minimize this problem is to have one or more graphical artists 125 (e.g., professional draftsman) on site to draw the design layout while the customer is still at the retail location. However, most retail locations do not have the resources to have both a salesperson and a professional draftsman on site to help the customer 105, and therefore this option is not desirable, although currently performed by some businesses.

An additional problem in the engraving industry is the lack of software that allows the salesperson or the customer to track the production of the order as it proceeds through the various stages. Without this software, the customer is unable to easily track the status of the order. Furthermore, when the customer 105 does seek the status of their order, this takes time away from the salesperson and/or the vendor.

In the engraved product industry, the customer has a strong need for accuracy and customer satisfaction with the finished engraved product. A problem with the conventional process for designing and ordering an engraved product is that a customer does not know what the finish product will look like until the finished product is received, or alternatively, the design layout 135 of the finished product is received. Businesses typically go the design layout 135 route, as opposed to providing the finish product that may or may not satisfy the customer, especially in the memorial industry, where customers are emotional, deadlines are very tight, and absolute accuracy is required. Although an error such as a typo would clearly not satisfy the customer, even a finished product that is correct can lead to problems when it does not meet the customer's aesthetic expectations.

An additional concern in the engraved product industry, especially with regard to memorials, is the existence of deadlines such as a funeral or another event. As a result, the ordering process is often time sensitive, such that the finished product needs to be done correctly the first time. If not, correcting the finished product or starting again from scratch with on a new engraved product is time consuming and expensive, as the materials need to be repurchased, the engraving needs to be redone, and the product needs to be reshipped.

Although some of the above customer satisfaction problems can be resolved by providing the design layout 135 of the finished product, prior to the engraving or shipping of the actual finished product, the creation of the design layout 135 and getting the approval on the design layout 135 adds extra time to what is typically a time sensitive process.

A further concern in the engraved product industry, especially with memorials, is the high level of emotion and stress. Although this can affect the customer's satisfaction and deadlines, this also means many customers want the initial ordering process to be completed in no more than one session. This concern is often larger than in other industries, where there are also reasons for wanting the process over in a single session, such as the sale is gone once the customer walks out the retailer's door or exits the retailer's website.

U.S. Pat. Pub. No. 2011/0208609 to Destephen et al. provides a method for creating a personalized sculpture comprising the using of at least one computer system, the computer system further comprising at least one template database and at least one server. The personalizing of at least one sculpture using at least one template database by allowing at least one customer to access the computer system from at least one computer terminal via the Internet. The method continues by receiving personalized sculpture orders using the computer system and sending personalized sculpture orders to a manufacturing facility using the computer system and storing information about the customers at least one database within the computer system. The system finally manufactures at least one personalized sculpture from the information stored in the at least one database.

U.S. Pat. No. 7,894,924 to Proudfoot discloses a system and method for manufacturing a memorial. The method provides a blank pattern in a memorial design and collaboration system having a specified shape and size, and building a memorial preview thereon, then sending the memorial preview to a host computer. The host computer routes the memorial preview as a stored file to a manufacturer for projecting, onto a three-dimensional solid in the shape of said blank pattern.

However, Destephen and Proudfoot do not allow the ability for a person who is not a professional artist to create the design layout, do not allow the ability to track or monitor the production process after ordering, and do not allow a customized design template to be imported by a customer. Additionally, Destephen is unrelated to engraved products, such as a memorial engraved into the stone, and their associated satisfaction problems and deadlines with designing and ordering.

### SUMMARY OF THE INVENTION

The present invention provides, in at least one embodiment, a computer software program configured to receive information from a customer, provide one or more design template choices, and receive an order for an engraved product with their design. The design can be created by the customer as opposed to a professional artist and allows the customer to see with confidence what the finished engraved product is going to look like prior to ordering. The computer software program includes an order tracking module which allows the customer to track the order throughout production and delivery.

In one embodiment, a computer software program that allows a customer to provide information that is enter into the software and used to create a custom layout that can be approved by the customer for the purpose of engraving a granite memorial or other engraveable personalized items. The computer software program comprises: an input form configured to collect information from a customer, wherein the information will be engraved into an engraved product; the computer software program configured to provide one or more design layout options to the customer containing the collected information to create the custom layout; the computer software program configured to display the design to the customer in real time prior to receiving an order of a design created by the customer; the computer software program configured to receive the order from the customer; the order comprising the design created by the customer to be engraved onto the engraved product; an output configured to send the order to a vender, wherein the vender engraves the design into the engraved product and delivers the engraved product; and an order tracking module connected to the computer software program, wherein the order tracking module is configured to allow the customer to track a status of one or more steps required to complete the order including tracking production and delivery.

The engraved product may comprise a memorial of stone with an engraved design. The design may comprise a nonprofessional design and the customer may comprise a non-professional artist. The design may comprise artwork and the vender may comprise a manufacturer. The system may further comprise allowing a salesperson, a customer or another user to provide the input information and create a custom layout. The computer software program may be configured to receive the custom layout directly from the customer and configured to add the collected information. The computer software program may be configured to provide a link to the customer.

In another embodiment, a method comprises the steps of: collecting information from a customer, wherein the information will be engraved into a product; providing one or more design layout options to the customer containing the collected information to create a custom layout; displaying the design to the customer in real time prior to receiving an order of a design created by the customer; receiving the order from the customer, the order comprising the design created by the customer to be engraved onto the engraved product; sending the order to a vender, wherein the vender engraves the design into the engraved product and delivers the engraved product; and using an order tracking module to allow the customer to track a status of one or more steps required to complete the order including tracking production and delivery.

An advantage of the present invention is that the customer can see what the finished engraved product is going to look like, during the first session (e.g., in 15 minutes) and prior to the purchase. This addresses the high need for customer satisfaction, strong deadlines, and the inherent emotion when ordering a memorial. Also, in the memorial industry, this allows the customer to purchase a memorial while purchasing other cemetery related needs, such as flowers, a plot, and a casket on the same day.

Another advantage is that the customer can track the status of their order as it progresses through the manufacturing and delivery process. Also, the customer can find status updates quickly, and the vendor spends less time providing these updates.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a conventional memorial ordering system that exists in the prior art;

FIG. 2 illustrates a high level diagram of a system according to an embodiment of the invention;

FIG. 3 illustrates the interactions of an order tracking module of the system according to an embodiment of the invention;

FIG. 4 illustrates a detailed view of the system according to an embodiment of the invention;

FIG. 5 illustrates a plurality of modules of the system according to an embodiment of the invention;

FIG. 6 illustrates the process of ordering an engraved product from the customer's perspective according to an embodiment of the invention; and

FIG. 7 illustrates the process of ordering an engraved product from the manufacturer's perspective according to an embodiment of the invention.

### DETAILED DESCRIPTION OF EMBODIMENTS

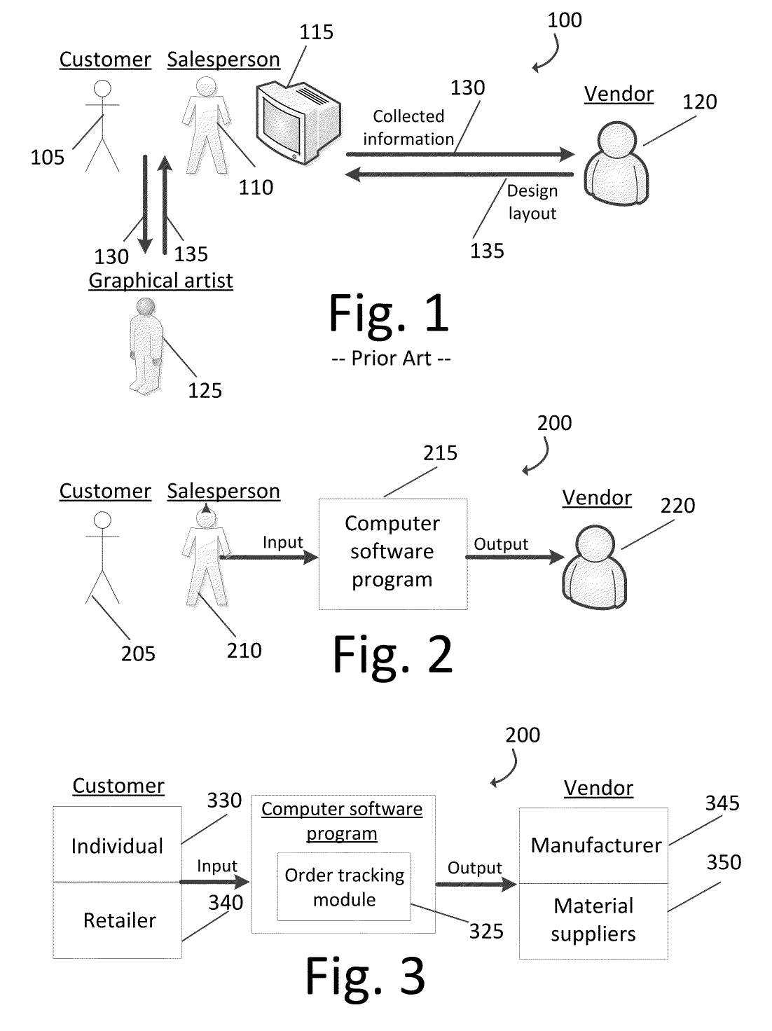

Further features and advantages of the invention, as well as the structure and operation of various embodiments of the invention, are described in detail below with reference to the accompanying FIGS. 1-7, wherein like reference numerals refer to like elements.

Although the invention is at times described in the context of customized designs created by the user, the designs can also include non-customized that are not created by the user, such as the plain text of a person's name. Additionally, although the computer software program is illustrated as being connected through a network, one of ordinary skill in the art readily appreciates that the present invention can be implemented locally on the customer's computer and the vendor's computer without departing from the spirit of the invention.

Embodiments of the present invention provide a unique computer software program that allows anyone to generate a design for an engraved product such as a memorial, see exactly what it is going to look like before placing the order, and then track the production of that order through the process until completion. The computer software program provides the ability for the customer to provide information about a deceased person and see it displayed immediately, in a graphical manner, prior to purchasing. Unlike conventional memorial ordering systems which require many steps and significant effort prior to a design being approved by the customer, the computer software shows to the customer in real time exactly what the design is going to look like in order to receive the much desired approval. For a cemetery counselor and manufacturer that receive many customers per day, week, and month, this time and effort savings is significant.

FIG. 2 illustrates a high level diagram of a system 200 according to an embodiment of the invention. The system 200 includes a customer 205, a salesperson 210, a computer software program 215, and a vender 220. The system 200 allows the customer 205 or the salesperson 210, both of which are not professional artists, to create a design for an engraved product, such as memorial that will be engraved into stone by the vender 220.

The customer 205 (e.g., a user) wants to create a design on an engraved product which can be viewed and approved by the customer 205 on the fly. The customer 205, or the salesperson 210, plugs in information regarding the engraving, picks a design or imports their own design, and then views the design on a computer prior to ordering to see what the finished product would look like.

The salesperson 210 works with the customer 205 to submit an order. In the memorial embodiment, the salesperson 210 is a cemetery counselor who sells memorials along with other cemetery products to the families of the deceased. The products sold include a casket, a plot, flowers, a memorial, etc. In a preferred embodiment, both the salesperson 210 and the customer 205 have no specific knowledge of graphic design software.

The computer software program 215 acts as a type of business management software that allows the customer 205 to design, order, and track custom products manufactured by the vender 220.

The computer software program 215 utilizes a web-based interface to produce customized designs and allow ordering of the designs. The computer software program 215 includes a web server, which includes the hardware (e.g., the computer) and/or software (e.g., the computer application) to deliver web content accessible through the Internet.

The computer software program 215 allows non-professionals to design and buy or sell custom products. The software allows these people to utilize a web-based interface to order products and produce customized artwork without specific knowledge of graphic design software. The customized artwork is translated into a file that can be read by a vector based graphic arts application. The order process is managed by workflows that are specific to the product being produced. The real time status of an order can be viewed any time after the order is placed. The software facilitates communication regarding the order between multiple parties.

Advantageously, the computer software program 215 takes a process for getting a customer's approval for a design layout from 2 to 3 days down to a few minutes. This is accomplished by the computer software program 215 allowing the customer 205 to insert information to be engraved, the customer selecting or importing a design, then seeing what the finished engraved product will look like prior to ordering, and then ordering the engraved product. This process is accomplished without the need to wait for a sample from the vender 220 and does not require a professional artist.

The computer software program 215 also advantageously allows the customer 205 to import their own design, although the design selected can be a template from the vender 220 as well. This additional functionality is beneficial to a customer 205 who would like to fully customize the engraved product. Another advantage is that the computer software program illustrates what products prior to engraving are currently in stock in the vendor's inventory, including colors and sizes of the product.

The computer software program 215 can connect to and leverage conventional business management software that exists for companies to use, store, and manage data from every stage of business. This business software is also referred to as enterprise resource planning software, which is usually a suite of integrated applications, such as product planning, cost and development, manufacturing, marketing and sales, inventory management, shipping and payment.

The vender 220 can be a manufacturer, or a combination of the manufacturer and material suppliers who provide materials to the manufacturer. The vendor 220 receives the order from the output of the computer software program 215, engraves the product, and ships the engraved product to the customer 205. The vender 220 must be very cautious that the order is engraved accurately since memorials are engraved into the stone and preserve a memory. An exemplary memorial is a headstone which is common at burials.

FIG. 3 illustrates the interactions of an order tracking module 325 of the system 200 according to an embodiment of the invention. The customer can include an individual 330 and/or a retailer 340.

In the memorial industry, typically an individual 330 is the customer that buys an engraved product. The individual 330 is typically a family member of a loved one that passed away. The individual 330 can be assisted by a family member, a friend, or the salesperson 210. It is common in the memorial industry for the customer to work together with the salesperson 210 to design an engraved memorial along with other purchases, where neither person is a professional draftsman. In the memorial industry, the salesperson is a cemetery counselor who acts as a middleman between the customer 205 and the vendor 220.

In other industries, such as skateboards, the retailer 340 is the customer that buys the engraved product. The retailer 340 obtains an engraved product to sell that to an end customer. The engraving can be on the underside of the skateboard's deck. Like the individual 330, the salesperson 210 can assist the retailer 340 in making an order.

The order tracking module 325 connects the customer 205 to the status of the order with the vendor 220 from moment the customer 205 completes the order to the time that the order is delivered. In a preferred embodiment, the customer 205 is sent a link that will continually show the status of their order. In one embodiment, the status of the engraved design is in production, completed, or delivered. In another embodiment, the status includes the location of the materials (e.g., an unengraved memorial has not shipped from the quarry yet) or the location of the engraved finished product. The order tracking module 325 gives more information to the customer such that the customer requires less interaction with the vendors and can obtain status updates update faster.

In one embodiment, the order tracking module 325 provides information to the customer 205 regarding the status of their order. A bar code (also referred to as a bar code label or bar code identification) contains an identification number, which is generated and assigned by the computer software program 215 for tracking purposes. After the manufacturer 345 reviews the artwork for quality control, by a review desk quality control check, the manufacturer 345 prints a bar code label and clips it to the film positive of a photoresist film used to engrave the product. The bar code is then applied to the product to be engraved (e.g., a memorial) prior to blasting the engraved artwork onto the product. The bar code is used to report on the status of the product throughout the manufacturing process.

The vendor 220 can be defined to include the manufacturer 345 alone, where the manufacturer subcontracts one or more material suppliers 350. In the memorial industry, the three main actors are typically viewed as the individual 330, the salesperson 210, and the manufacturer 345, where the individual is a family member of the deceased, the salesperson is a cemetery counsel, and the manufacturer is an engraving company.

In another embodiment, the vender 220 also includes the material suppliers 350. For example, the material suppliers 350 can provide a memorial, and the manufacturer 345 can engrave the customer's desired information into the memorial. Materials for the product being produced may need to be acquired, and are not known until the order is placed. The computer software program 215 provides an integrated inventory tracking and acquisition system for obtaining the needed materials. The software 215 allows the retailer to specify what products and options are available to their customer. Embodiments of the present invention include multi-tiered permission-based security allowing the simultaneous real-time viewing, modifying, and approving of an order by a retailer (e.g., a salesperson), customer of the retailer, and those authorized by the customer of retailer.

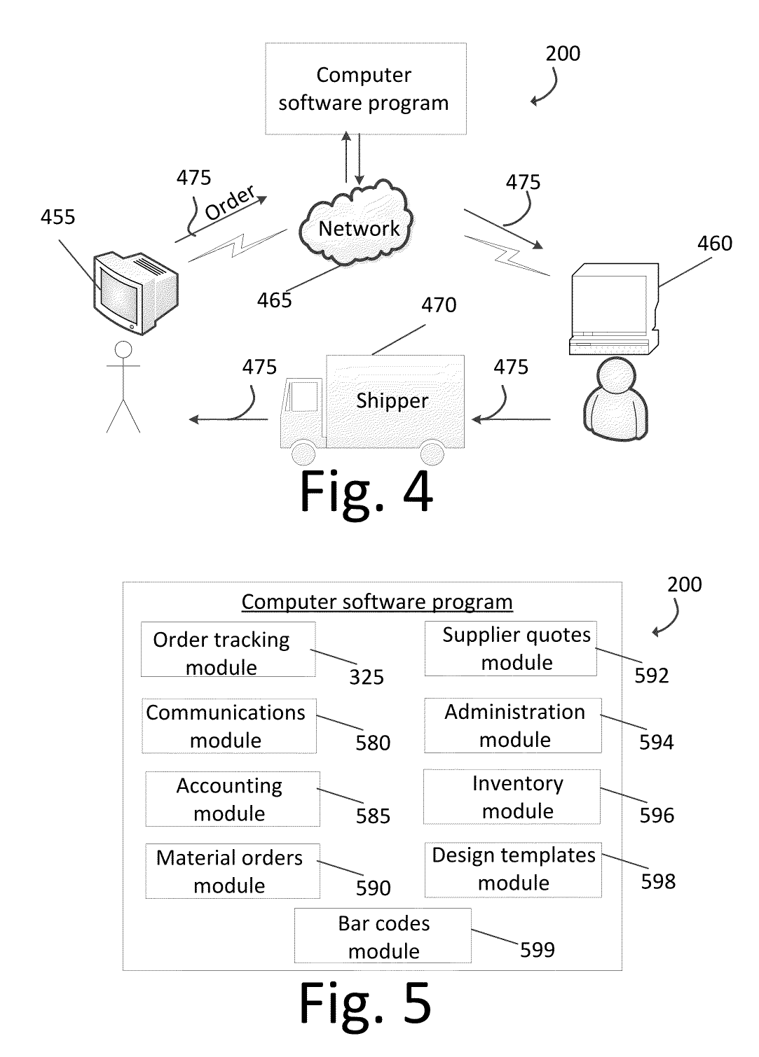

FIG. 4 illustrates a detailed view of the system 200 according to an embodiment of the invention. The system 200 includes a customer's terminal device 455, a vendor's terminal device 460, a network 465, a shipper 470, and an order 475. FIG. 2 illustrates the order 475 flowing from the customer's terminal device 455 to the vender's terminal device 460 through the network 465 leveraging the computer software program 215, before being shipped back by the shipper 470 to complete the order 475.

The customer's terminal device 455 is typically a computer, although it can be any other device known by one with skill in the art for transmitting the customer's order. Similarly, the vendor's terminal device 460 can be any device known by one with skill in the art for receiving the customer's order, such as a computer. The computer software program 215 allows for real time approval from the customer 205 for a process which conventional takes several days, which is of significant value in the memorial industry, with the concerns of emotional customers, tight deadlines and absolute accuracy.

The network 465 connects both the customer's terminal device 455 and the vendor's terminal device 460 to the computer software program 215. In one embodiment, the network is the Internet. The connection between the computer software program 215 and the devices 455, 460 can be a network access server.

The shipper 470 ships the order 475 to complete the purchase. Although illustrated as a delivery truck, one skilled in the art is aware of other methods for shipping engraved products, such as by boat or plane.

The order 475 includes a customized design for an engraved product. Additionally, the order can include any supplemental information to complete the order 475, such as a shipping address, estimated shipping date, contact information, special instructions, price, etc.

FIG. 5 illustrates a plurality of modules of the system 200 according to an embodiment of the invention. The modules include the order tracking module 325, a communications module 580, an accounting module 585, a material orders module 590, a supplier quotes module 592, an administration module 594, an inventory module 596, a design templates module 598, and a bar codes module 599. One with skill in the art could include additional modules.

The communications module 580 provides a location for storing communications between the customers 205, vendor, and the customer 205 and the vendor. The communication module 580 acts as a replacement for email but is much better than email for several reasons.

One reason is the difficulty of searching for all the emails for a particular customer. In an industry where there are hundreds of customers per month, trying to search for all the emails associated with one order, which is needed to make sure the all the instructions are received, is very difficult.

Another reason why the communication module 580 is better than email is preventing lost communication. When a customer has information that must end up in the engraved product, but the communication occurs prior to the design reaching the vendor or while the salesperson 210 is on vacation, the communication is lost, which can lead to errors in producing the engraved product. The communication module 580 provides a central spot for changes in the design to occur.

A further reason why the communication module 580 is better than email is that some customers would prefer to not be automatically pushed email updates on the ordering process and instead wish to manually pull updates when they are ready, such as visiting as websites to view the status of the order. This can be due to the emotional nature of the memorial industry or due to the large quantity of steps required to complete the order.

The communication module 580 allows everyone to see communications that are intended to be viewable by others. In one embodiment, all communication using the communication module 580 are published. In another embodiment, the customers 205 and vendors can control whether or not a particular communication using the communication module 580 is published (e.g., price quotes from the material suppliers 350 are not published).

The accounting module 585 contains the customer's active orders and order history of completed orders. The accounting module 585 can work together with an accounting system (not shown) which includes conventional accounting software, such as Sage100 sold by the Sage Group PLC, who sells business management and accounting software for businesses.

The material orders module 590 stores pending material orders from one of the material suppliers 350, completed orders, and information about what the material suppliers 350 have in their catalogs. The supplier quotes module 592 contains new quote requests from the material suppliers 350 and the history of completed quotes. The administration module 594 contains miscellaneous features such as security, user access, and navigation features of the computer software program 215. The inventory module 596 allows the customer 205 to view what the vendor 220 has in stock prior to making an order. The design templates module provides 598 sample design layout options for the customer 205 to choose from, unless the customer 205 decides to import their own design. The bar codes module 599 is configured to generate an identification number to be added to the engraved product.

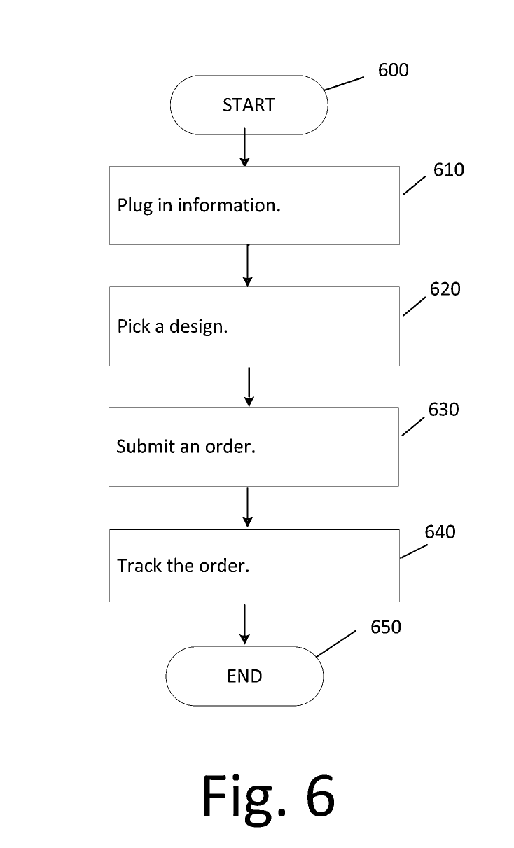

FIG. 6 illustrates the process of ordering an engraved product from the customer's perspective according to an embodiment of the invention. The process starts at step 600. At step 610, the customer 205 or the salesperson 210 enters information into the software regarding the engraved product. In the memorial embodiment, the information may include the deceased's name, date of birth, date of death, and a memorable quote. At step 620, the customer 205 picks a design from one or more choices or advantageously imports the customer's own design. Unlike the prior art process where the customer must submit the information and wait for a design layout by a professional graphic artist, the system 200 shows the customer 205 exactly what the design will look prior to submitting the order.

At step 630, the customer 205 submits the order. At step 640, the system 200 allows the customer 205 the option to track the order using a link and a bar code as it proceeds through production, a feature highly desired and currently unavailable in the art. The process may be repeated recursively a number of times and ends at step 650.

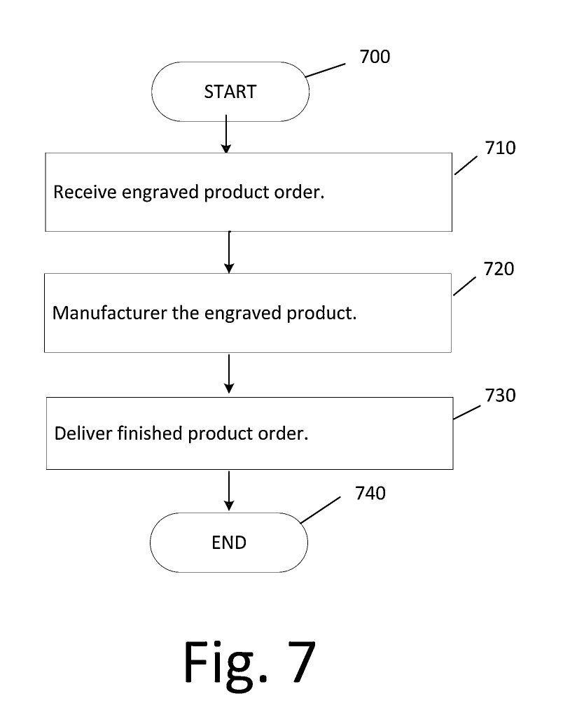

FIG. 7 illustrates the process of ordering an engraved product from the manufacturer's perspective according to an embodiment of the invention. The process starts at step 700. At step 710, the vender 220 receives an engraved product order from the customer 205 including a design submitted by the customer 205. The engraved product can be a memorial, such as a headstone. At step 720, the vender 220 manufactures the engraved product using the design submitted by the customer 205 including a bar code. At step 730, the shipper 470 delivers the finished product order. The process may be repeated recursively a number of times and ends at step 740.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A computer software program that allows a customer to easily enter information such as name and dates to create and approve a custom layout for the purpose of engraving a granite memorial or other engraveable personalized items, the computer software program comprising:
an input configured to collect information from a customer, wherein the information will be engraved into an engraved product;
the computer software program configured to provide one or more design layout options to the customer containing the collected information to create the custom layout;
the computer software program configured to display the design to the customer in real time prior to receiving an order of a design created by the customer;
the computer software program configured to receive the order from the customer, the order comprising the design created by the customer to be engraved onto the engraved product;
an output configured to send the order to a vender, wherein the vender engraves the design into the engraved product and delivers the engraved product;
an order tracking module connected to the computer software program, wherein the order tracking module is configured to allow the customer to track a status of one or more steps required to complete the order including tracking production and delivery; and
a bar code system that allows the vender to track and report on the status of the product during the manufacturing process.

2. The system of claim 1, wherein the engraved product comprises a memorial.

3. The system of claim 1, wherein the engraved product comprises stone and the stone is configured to be engraved.

4. The system of claim 1, wherein the design comprises a nonprofessional design and the customer comprises a non-professional artist.

5. The system of claim 1, wherein the design comprises artwork.

6. The system of claim 1, wherein the vender comprises a manufacturer.

7. The system of claim 1 further comprising allowing a salesperson or another user to provide the input information and create the custom layout.

8. The system of claim 1, wherein the computer software program is configured to receive the custom layout directly from the customer and configured to add the collected information.

9. The system of claim 1, wherein the computer software program is configured to provide a link to the customer.

10. The system of claim 1, wherein the computer software program is configured to generate an identification number to be added to the engraved product.

11. A method comprising:
collecting information from a customer, wherein the information will be engraved into an engraved product;
providing one or more design layout options to the customer containing the collected information to create a custom layout;
displaying the design to the customer in real time prior to receiving an order of a design created by the customer;
receiving the order from the customer, the order comprising the design created by the customer to be engraved onto the engraved product;
sending the order to a vender, wherein the vender generates a barcode to track and report on the status of the product, engraves the design into the engraved product and delivers the engraved product; and
using an order tracking module to allow the customer to track a status of one or more steps required to complete the order including tracking production and delivery.
